(19) United States
(12) Patent Application Publication
(10) Pub. No.: US 2016/0318494 A1
(43) Pub. Date: Nov. 3, 2016

(54) COMPUTER-IMPLEMENTED METHODS AND SYSTEMS FOR WHEELIE CONTROL IN DIWHEEL-TYPE AUTONOMOUS MOBILE ROBOTS

(71) Applicant: Harvest Automation, Inc., Billerica, MA (US)

(72) Inventors: Joseph R. Henry, Westford, MA (US); Clara Vu, Cambridge, MA (US); Ilya A. Kriveshko, Boxborough, MA (US); John D. Heinzmann, JR., Manchester, NH (US)

(73) Assignee: HARVEST AUTOMATION, INC., Billerica, MA (US)

(21) Appl. No.: 14/483,458

(22) Filed: Sep. 11, 2014

Related U.S. Application Data
(60) Provisional application No. 61/876,401, filed on Sep. 11, 2013.

(51) Int. Cl. B60T 8/58; B25J 5/00; B62D 61/00; B60T 8/18

(52) U.S. Cl. CPC B60T 8/58; B60T 8/18; B25J 5/007; B62D 61/00; B60T 2230/02; Y10S 901/01

(57) ABSTRACT

Computer-implemented methods and systems are disclosed for inhibiting wheelies in diwheel-type autonomous mobile robots. The pitch rate of the robot is detected while the robot is traveling. When the pitch rate exceeds a given threshold, acceleration of the robot is attenuated proportionally to the pitch rate in order to inhibit the robot from performing a wheelie. The process is repeatedly performed at a high frequency.

### CROSS REFERENCE TO RELATED APPLICATION

This application claims priority from U.S. Provisional Patent Application No. 61/876,401 filed on Sep. 11, 2013 entitled WHEELIE CONTROLLER FOR DIWHEEL-TYPE AUTONOMOUS MOBILE ROBOTS, which is hereby incorporated by reference.

### BACKGROUND

The present application relates generally to diwheel-type autonomous mobile robots and, more particularly, to methods and systems for wheelie control in such robots.

### BRIEF SUMMARY

Computer-implemented methods and systems are disclosed for inhibiting wheelies in diwheel-type autonomous mobile robots. The pitch rate of the robot is detected while the robot is traveling. When the pitch rate exceeds a given threshold, acceleration of the robot is attenuated proportionally to the pitch rate in order to inhibit the robot from performing a wheelie. The process is repeatedly performed at a high frequency.

In accordance with one or more embodiments, a computer-implemented method is provided for inhibiting wheelies in a mobile robot. The robot includes a drive subsystem controlled by a microprocessor-based controller subsystem and a pitch rate determining apparatus. The method includes the steps of: (a) detecting, using the pitch rate determining apparatus, a pitch rate of the robot while the robot is traveling; (b) controlling the drive subsystem, using the controller subsystem, to attenuate acceleration of the robot proportionally to the pitch rate detected in step (a) when the pitch rate exceeds a given threshold in order to inhibit the robot from performing a wheelie; and (c) repeatedly performing steps (a) and (b) while the robot is traveling.

A mobile robot in accordance with one or more embodiments includes a chassis, a drive subsystem for maneuvering the chassis, a pitch rate determining apparatus for detecting a pitch rate of the robot while the robot is traveling, and a controller subsystem on the chassis for controlling the drive subsystem and for inhibiting wheelies. The controller subsystem includes at least one processor, memory associated with the at least one processor, and a program supported in the memory containing a plurality of instructions which, when executed by the at least one processor, cause the at least one processor to: (a) identify the pitch rate of the robot using the pitch rate determining apparatus; (b) control the drive subsystem to attenuate acceleration of the robot proportionally to the pitch rate identified in (a) when the pitch rate exceeds a given threshold in order to inhibit the robot from performing a wheelie; and (c) repeatedly perform (a) and (b) while the robot is traveling.

In accordance with one or more further embodiments, a computer-implemented method is provided for inhibiting wheelies in a mobile robot. The robot includes a drive subsystem controlled by a microprocessor-based controller subsystem. It is also equipped with a pitch rate determining apparatus and a center of gravity management system. The method includes the steps of: (a) detecting, using the pitch rate determining apparatus, a pitch rate of the robot while the robot is traveling; (b) controlling the center of gravity management system, using the controller subsystem, to adjust a center of gravity of the robot when the pitch rate detected in step (a) exceeds a given threshold in order to inhibit the robot from performing a wheelie; and (c) repeating steps (a) and (b) a plurality of times while the robot is traveling.

A mobile robot in accordance with one or more further embodiments includes a chassis, a drive subsystem for maneuvering the chassis, a pitch rate determining apparatus for detecting a pitch rate of the robot while the robot is traveling, a center of gravity management system, and a controller subsystem on the chassis for inhibiting wheelies. The controller subsystem includes at least one processor, memory associated with the at least one processor, and a program supported in the memory containing a plurality of instructions which, when executed by the at least one processor, cause the at least one processor to: (a) identify the pitch rate of the robot using the pitch rate determining apparatus; (b) control the center of gravity management system to adjust a center of gravity of the robot when the pitch rate identified in (a) exceeds a given threshold in order to inhibit the robot from performing a wheelie; (c) repeatedly perform (a) and (b) while the robot is traveling.

### BRIEF DESCRIPTION OF THE DRAWINGS

FIG. 1 is a perspective view of an exemplary autonomous mobile robot equipped with a gyroscope-based wheelie controller in accordance with one or more embodiments.

FIG. 2 is a simplified block diagram showing selected components of the exemplary robot of FIG. 1.

### DETAILED DESCRIPTION

Autonomous mobile robots are used in a variety of industries, including in the agricultural industry. By way of non-limiting example, one particular use of autonomous robots is for performing automated potted plant processing operations. Specifically, robots can be used to identify, pick up, transport, and deposit container-holding plants as disclosed in co-pending U.S. patent application Ser. No. 12/378,612 filed on Feb. 18, 2009 and entitled ADAPTABLE CONTAINER HANDLING SYSTEM and U.S. patent application Ser. No. 13/100,763 filed on May 4, 2011 and entitled ADAPTABLE CONTAINER HANDLING ROBOT WITH BOUNDARY SENSING SUBSYSTEM.

Such robots can operate at high speeds and can be significantly damaged in accidents. Diwheel-type robots (i.e., robots having two wheels sharing a common axle or axis) may be prone to going into a wheelie under certain conditions, in which the front of the robot lifts up, possibly causing the robot to tip over and become damaged. In accordance with one or more embodiments, methods and systems are provided to inhibit wheelies in diwheel-type robots.

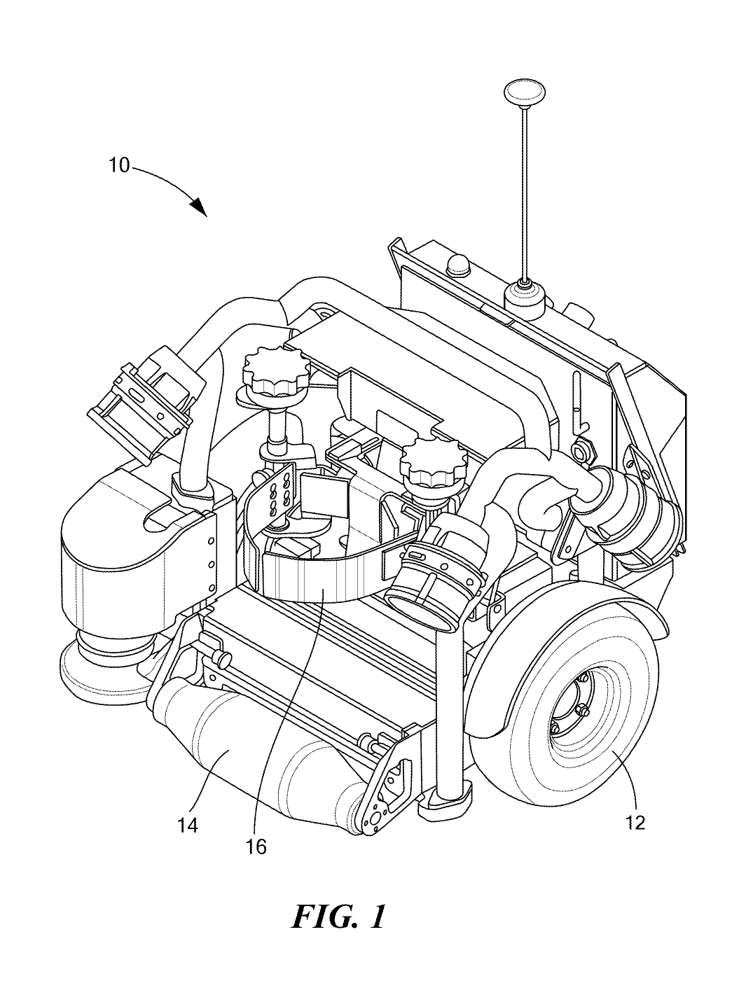

FIG. 1 illustrates an exemplary autonomous mobile robot 10 equipped with gyroscope-based wheelie controller in accordance with one or more embodiments. The robot 10 is a diwheel-type robot having two wheels 12 on a common axle. The robot 10 also includes a roller assembly 14 mounted at the front end of the robot 10, which supports and provides stability to the robot 10 during movement.

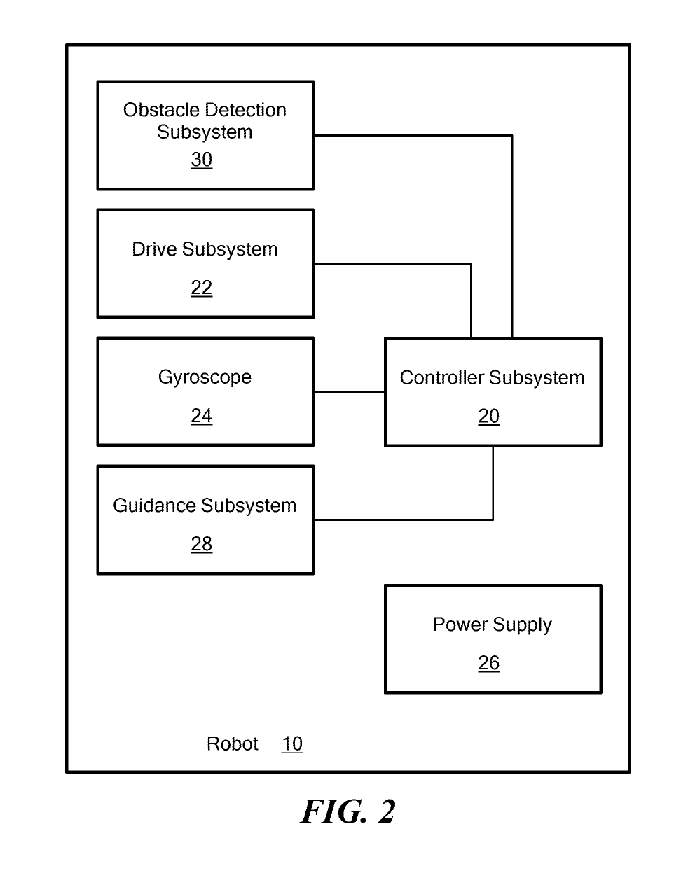

FIG. 2 is a block diagram showing selected components of the exemplary robot 10. Among other components, the robot 10 includes a microprocessor-based controller subsystem 20 for controlling operation of the robot 10 in performing programmed behaviors, including inhibiting wheelies.

The robot 10 also includes a drive subsystem 22 (which is controlled by the controller subsystem 20) for maneuvering the robot 10. The drive subsystem 22 can comprise a differential drive including the two coaxial wheels 12 and a roller. The wheels 12 can be driven together or independently by one or more motors and a drive train as controlled by the controller subsystem 20.

The robot 10 also includes a pitch rate gyroscope 24 for providing information on the pitch rate of the robot 10 to the controller subsystem 20 at high frequency. By way of example, the pitch rate gyroscope 24 can comprise a model ADXRS453 angular rate sensor available from Analog Devices, Inc. Other possible mechanisms for determining pitch rate can also be used including, e.g., a set of two or more accelerometers.

A power supply 26 for all the subsystems can include one or more rechargeable batteries.

The controller subsystem 20 is configured (e.g., programmed) to cause the robot 10 to perform various functions such as, e.g., transporting items between endpoints. The controller subsystem 20 can be responsive to the output of a guidance subsystem 28 and an obstacle detection subsystem 30, and controls the drive subsystem 22 to maneuver the robot 10 to prescribed locations.

The controller subsystem 20 is also programmed by control software to monitor the output of the pitch rate gyroscope 24 and, in response, alter acceleration and velocity of the robot 10 when the pitch rate exceeds a given threshold in order to inhibit wheelies.

Wheelies can be induced by quick forward acceleration of the robot 10. Wheelies can also be induced when the front of the robot 10 (e.g., the front roller of the robot) impacts small debris in its path such as rocks. Wheelies can also be induced when the robot 10 is stopped very quickly when driving in reverse.

Debris impacts are detected by the controller subsystem 20 when very high pitch rate readings are returned from the gyroscope 24. In response, the controller subsystem 20 can command the robot 10 to brake in order to slow down when the pitch rate exceeds a maximum acceptable threshold. Braking applies a forward torque around the wheel contact points and forces the front end down, thereby inhibiting wheelies.

The controller subsystem 20 preferably receives and evaluates information from the pitch rate gyroscope 24 at a high frequency (e.g., 200 Hz). The pitch rate readings are integrated over time by the controller subsystem 20 to determine the pitch angle of the robot 10. When the pitch angle exceeds a maximum acceptable threshold, braking is applied. In one exemplary implementation, the threshold is 5 degrees.

The robot 10 is balanced such that in the absence of outside forces, gravity holds the front end down. Nevertheless, if the robot 10 accelerates too quickly, the front end comes up. During forward acceleration, the control software monitors the pitch rate gyroscope 24 to detect an induced wheelie. Acceleration is reduced or momentarily stopped to allow gravity to counteract the wheelie. Since the gyroscope 24 is monitored at a high frequency, wheelies are detected early and mitigated before the front end of the robot 10 can come up significantly.

A linear relationship between the robot's acceleration and pitch rate is enforced by the following exemplary code passage in code processed by the controller subsystem 20. Enforcing a linear relationship between the pitch rate of the robot 10 with its acceleration enables maximum acceleration to be achieved without going into a wheelie.

m_attenuation = m_maxAttenuation

* ( m_pitchRate − m_pitchRateAttThreshold )
/ ( m_pitchRateAttCeiling − m_pitchRateAttThreshold );

```
// Sanity check threholds.
if ( m_attenuation > m_maxAttenuation ) {
  m_attenuation = m_maxAttenuation;
}
if ( m_attenuation < 0 ) {
  m_attenuation = 0;
}
m_adjustedAcceleration = m_acceleration *
```

( 1.0f − m_attenuation );

The mathematical formulas in the code above can also be expressed as follow:

attenuation=max*(rate−threshold)/(ceiling−threshold)

acceleration=planned acceleration*(1−attenuation)

Where:
planned_acceleration is a desired rate of acceleration for the robot.
acceleration is the rate at which the robot will be allowed to accelerate with the current pitch rate.
attenuation is the fraction by which to reduce the robot's planned acceleration based on the pitch rate.
max is the maximum desirable attenuation value (ranging from 0 to 1).
rate is the measured pitch rate of the robot.
threshold is the highest tolerable pitch rate; pitch rates below the threshold are ignored.
ceiling is the highest acceptable pitch rate; beyond this rate maximum attenuation will be applied.

In accordance with one or more alternate embodiments, a center of gravity management system is provided to inhibit robot wheelies. Specifically, the robot is equipped with a movable arm 16 that carries a payload (which can, e.g., comprise a potted plant for robots performing automated potted plant processing operations) whose position can be adjusted by the controller subsystem 20. For instance, the arm 16 can be positioned forward or accelerated rearward during forward robot acceleration to help hold the front end down. Similarly, the arm 16 could be positioned rearward or accelerated forward when the robot 10 is accelerating in a reverse direction.

The processes of the controller subsystem 20 described above may be implemented in software, hardware, firmware, or any combination thereof. The processes are preferably implemented in one or more computer programs executing on a computer processor. Each computer program can be a set of instructions (program code) in a code module resident in the random access memory used by the processor. Until required by the processor, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments. Additionally, elements and components described herein may be further divided into additional components or joined together to form fewer components for performing the same functions. Accordingly, the foregoing description and attached drawings are by way of example only, and are not intended to be limiting.

What is claimed is:

1. A computer-implemented method for inhibiting wheelies in a mobile robot having a drive subsystem controlled by a microprocessor-based controller subsystem, said robot also equipped with a pitch rate determining apparatus, the method comprising the steps of:
(a) detecting, using the pitch rate determining apparatus, a pitch rate of the robot while the robot is traveling;
(b) controlling the drive subsystem, using the controller subsystem, to attenuate acceleration of the robot proportionally to the pitch rate detected in step (a) when the pitch rate exceeds a given threshold in order to inhibit the robot from performing a wheelie; and
(c) repeatedly performing steps (a) and (b) while the robot is traveling.

2. The method of claim 1, wherein acceleration of the robot is attenuated by enforcing a linear relationship between the pitch rate and acceleration of the robot to enable generally maximum acceleration of the robot without causing a wheelie.

3. The method of claim 1, further comprising determining a pitch angle of the robot from the pitch rate, and controlling the drive subsystem to slow the robot down when the pitch angle exceeds a given pitch angle threshold.

4. The method of claim 3, wherein determining a pitch angle of the robot from the pitch rate comprises integrating pitch rate readings over time.

5. The method of claim 1, wherein the robot is a diwheel robot.

6. The method of claim 1, wherein the robot is an autonomous robot adapted for automated potted plant processing operations.

7. The method of claim 1, wherein the pitch rate determining apparatus comprises a pitch rate gyroscope or a set of accelerometers.

8. The method of claim 1, wherein steps (a) and (b) are repeatedly performed at a frequency of about 200 Hz.

9. A mobile robot, comprising:
a chassis;
a drive subsystem for maneuvering the chassis;
a pitch rate determining apparatus for detecting a pitch rate of the robot while the robot is traveling;
a controller subsystem on the chassis for controlling the drive subsystem and for inhibiting wheelies, the controller subsystem comprising at least one processor, memory associated with the at least one processor, and a program supported in the memory containing a plurality of instructions which, when executed by the at least one processor, cause the at least one processor to:
(a) identify the pitch rate of the robot using the pitch rate determining apparatus;
(b) control the drive subsystem to attenuate acceleration of the robot proportionally to the pitch rate identified in (a) when the pitch rate exceeds a given threshold in order to inhibit the robot from performing a wheelie; and
(c) repeatedly perform (a) and (b) while the robot is traveling.

10. The robot of claim 9, wherein acceleration of the robot is attenuated by enforcing a linear relationship between the pitch rate of the robot and acceleration of the robot to enable generally maximum acceleration of the robot without causing a wheelie.

11. The robot of claim 9, further comprising instructions which, when executed by the at least one processor, cause the at least one processor to determine a pitch angle of the robot from the pitch rate, and control the drive subsystem to slow the robot down when the pitch angle exceeds a given pitch angle threshold.

12. The robot of claim 11, wherein determining a pitch angle of the robot from the pitch rate comprises integrating pitch rate readings over time.

13. The robot of claim 9, wherein the robot is a diwheel robot.

14. The robot of claim 1, wherein the robot is an autonomous robot adapted for automated potted plant processing operations.

15. The robot of claim 9, wherein the pitch rate determining apparatus comprises a pitch rate gyroscope or a set of accelerometers.

16. The robot of claim 1, wherein (a) and (b) are repeatedly performed at a frequency of about 200 Hz.

17. A computer-implemented method for inhibiting wheelies in a mobile robot having a drive subsystem controlled by a microprocessor-based controller subsystem, said robot also equipped with a pitch rate determining apparatus and a center of gravity management system, the center of gravity management system including a movable arm attached to a chassis of the robot, the method comprising the steps of:
(a) detecting, using the pitch rate determining apparatus, a pitch rate of the robot while the robot is traveling;
(b) controlling the center of gravity management system, using the controller subsystem, to adjust a center of gravity of the robot by accelerating movement of the movable arm in a rearward direction when the pitch rate detected in step (a) exceeds a given threshold in order to inhibit the robot from performing a wheelie; and
(c) repeating steps (a) and (b) a plurality of times while the robot is traveling.

18. (canceled)

19. The method of claim 17 wherein the movable arm carries a payload.

20. The method of claim 17, comprising determining a pitch angle of the robot from the pitch rate, and controlling the drive subsystem to slow the robot down when the pitch angle exceeds a given pitch angle threshold.

21. The method of claim 20, wherein determining a pitch angle of the robot from the pitch rate comprises integrating pitch rate readings over time.

22. The method of claim 17, wherein the robot is a diwheel robot.

23. The method of claim 17, wherein the robot is an autonomous robot adapted for automated potted plant processing operations.

24. The method of claim 17, wherein the pitch rate determining apparatus comprises a pitch rate gyroscope or a set of accelerometers.

25. A mobile robot, comprising:
a chassis;
a drive subsystem for maneuvering the chassis;
a pitch rate determining apparatus for detecting a pitch rate of the robot while the robot is traveling;
a center of gravity management system including a movable arm attached to the chassis; and
a controller subsystem on the chassis for inhibiting wheelies, the controller subsystem comprising at least one processor, memory associated with the at least one processor, and a program supported in the memory containing a plurality of instructions which, when executed by the at least one processor, cause the at least one processor to:
(a) identify the pitch rate of the robot using the pitch rate determining apparatus;
(b) control the center of gravity management system to adjust a center of gravity of the robot by accelerating movement of the movable arm in a rearward direction when the pitch rate identified in (a) exceeds a given threshold in order to inhibit the robot from performing a wheelie;
(c) repeatedly perform (a) and (b) while the robot is traveling.

26. The robot of claim 25, further comprising instructions which, when executed by the at least one processor, cause the at least one processor to determine a pitch angle of the robot from the pitch rate, and control the drive subsystem to slow the robot down when the pitch angle exceeds a given pitch angle threshold.

27. The robot of claim 25, wherein determining a pitch angle of the robot from the pitch rate comprises integrating pitch rate readings over time.

28. The robot of claim 25, wherein the robot is a diwheel robot.

29. The robot of claim 25, wherein the robot is an autonomous robot adapted for automated potted plant processing operations..

30. The robot of claim 25, wherein the pitch rate determining apparatus comprises a pitch rate gyroscope or a set of accelerometers.
